(19) United States
(12) Patent Application Publication
(10) Pub. No.: US 2025/0315601 A1
(43) Pub. Date: Oct. 9, 2025

(54) MULTIPLE-ENTRY FORMATS FOR DATA TABLES

(71) Applicant: Microsoft Technology Licensing, LLC, Redmond, WA (US)

(72) Inventor: Paras Pankaj KAPADIA, Seattle, WA (US)

(21) Appl. No.: 18/629,282

(22) Filed: Apr. 8, 2024

(51) Int. Cl. G06F 40/177; G06F 40/103

(52) U.S. Cl. CPC G06F 40/177; G06F 40/103

(57) ABSTRACT

Systems, methods, and software are disclosed herein for multiple-entry formatting of cells in a data table in various implementations. In an implementation, a computing device receives a user selection of a display format for a cell in a data table in the user interface of an application. The selected display format defines visual arrangements of individual entries in cells based at least on entry characteristics of the individual entries. The computing device receives multiple individual entries into the cell and visually arranges the entries based on an entry characteristic of each of the entries in accordance with the display format. In an implementation, the multiple individual entries include entries that were entered and committed to the cell at different times. In the same or other implementation, the computing device receives a user request to display an expanded view of the multiple individual entries in the user interface.

### TECHNICAL FIELD

Aspects of the disclosure are related to the field of displaying structured or tabular data in a user interface of a software application.

### BACKGROUND

Data tables, such as those found in spreadsheet applications or database applications, dimensionally organize information according to structured arrangements of rows and columns, where each intersection represents a specific data point or information. Data tables are particularly amenable for project management because they provide a structured and organized way to store, track, and manage different types of project-related information, such as names of team members, dates, project tasks, and so on. By sharing access to the data table, users can individually update the table so other team members can readily avail themselves of the information. Moreover, the ability to format cells for different types of information enhances the utility of data tables, improving the effectiveness of the tables in terms of clarity and readability, data categorization, and data validation, as well as helping to ensure that users enter information in the correct location in the table, among other considerations.

Often, however, a single cell of a data table represents a quantity of information which exceeds the capacity of the cell to conveniently display. For example, a large quantity of information added to a single cell can cause the cell to swell to a disproportionate size, making the data table cumbersome to work with in the user interface. Solutions include fixing the row height, but this means limiting how much of the cell content can be viewed within the data table. Alternatively, multiple cells can be merged to create a larger cell, however, merging can cause issues with table operations such as sorting, filtering, or generating pivot tables, when printing the data table, or when copying the cell contents of the merged cell to another location in the table or to another table. Users can add a comment to a cell to include more information, but comments are more restrictive in terms visibility and may also have limited or no options for formatting. For data tables in spreadsheet applications, users may expand the formula bar to display the contents of the cell more fully, however, this limits how much of the data table is visible in the user interface.

### OVERVIEW

Technology is disclosed herein for systems and methods relating to a multiple-entry format of cells in a data table in various implementations. In an implementation, a computing device receives, in a user interface of an application, a selection of a display format for a cell in a data table. The selected display format defines visual arrangements of individual entries in cells based at least on entry characteristics of the individual entries. The computing device receives multiple individual entries into the cell and visually arranges the entries in the cell based on an entry characteristic of each of the multiple individual entries and in accordance with the display format. In an implementation, the multiple individual entries include entries that were entered and committed to the cell at different times. In the same or other implementation, the computing device receives user input including a request to display an expanded view of the multiple individual entries in the user interface.

In one example, visually arranging the multiple individual entries includes arranging the entries a set of cards layered in an order based on the entry characteristic of the multiple individual entries. The entry characteristic may be an order of entry or a user identity of each of the multiple individual entries.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for multiple-entry formatting of a cell in a data table in an implementation.

FIG. 2 illustrates a process for multiple-entry formatting of a cell in a data table in an implementation.

FIG. 3 illustrates an operational architecture for multiple-entry formatting of a cell in a data table in an implementation.

FIG. 4 illustrates a workflow for multiple-entry formatting of a cell in a data table in an implementation.

FIGS. 5A-5C illustrate user experiences for multiple-entry formatting of a cell in a data table in an implementation.

FIG. 6 illustrates a user experience for multiple-entry formatting of a cell in a data table in an implementation.

FIG. 7 illustrates a data structure for multiple-entry formatting of a cell in a data table in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein for formatting cells to display multiple independent entries in data tables of spreadsheet applications, project planning applications, or other applications. In an implementation, a user commits a series of individual entries to a cell of a data table. Each entry may be individually committed to the cell at different times. The application hosting the data table displays the entries in a format that visually distinguishes the entries as separate, independent entries but in such a way as to prevent the cell row or column from expanding to a cumbersome size, making the rest of the table difficult to view. In one implementation, the cell format depicts the multiple individual entries in a compressed view as a set of stacked or layered cards in the cell which visually indicates to the user that there are multiple individual entries in the cell. With the individual entries in a compressed view in the cell, the cell proportions (e.g., row height) remain manageable. When the user desires to make a new entry to the cell, the application pops up a new blank card at the top of the stack in which to receive the user's entry.

In various implementations of the multiple-entry format, to view the multiple entries of the cell, the application displays a graphical device, such as a graphical button or icon, which causes the application to surface an expanded view of the cell contents, such as an inline expansion of the cell (i.e., an expansion of the cell within the table) or an expansion pane displaying the multiple entries. In various implementations, the multiple entries are ordered in the cell according to a characteristic of the entries, such as the order or time of entry or the identity of a user or user account associated with the entry. In the compressed display, the top card of the card stack may display, for example, the most recent entry along with the timestamp of the entry. An expanded view may display the multiple entries according to their order of entry.

The multiple-entry format can be used to capture information which a single user or multiple users enter sequentially and which the user or users may wish to view according to a characteristic of the entry, such as the order of entry or the user entering the information. In some scenarios, the entries may be ordered for viewing by the content of the entries, such as alphabetical order. In this way, cell can hold multiple individual entries, display the most important entry in the cell, and present the user or users with the option to view all of the entries without making the cell disproportionately large and without having to arrow through the multiple entries in a formula bar.

In an exemplary scenario of multiple-entry formatting, users collaborating on a project may display a data table on a shared project canvas. Each row of the data table may include information for a particular task associated with the project. A column of the data table may be designated for status information for each of the tasks, with the column formatted to receive multiple individual entries in the cells. The status column may be formatted to receive multiple entries so that the collaborators can submit updates about a particular task in the respective cell. As each user adds an update about a task to its status cell, the cell stores each of the updates as individual entries along with metadata or characteristics about each entry, such as the date and time information of when entries were made, the user making the entry, and/or an event, such as a meeting or call, associated with the entry. When an entry is made to a status cell, the data table displays the information in a manner which indicates that there are multiple entries. In the cell, the most recent entry is displayed along with a button or icon for generating an expanded view of the entries. To display an expanded view of the entries, the application may surface a pane showing the updates in order of when they were entered (along with a scroll bar as necessary), or the application may expand the cell within the table to display a few of the entries (e.g., the three most recent entries) and may display a scroll bar in the cell by which the user can scroll through all the entries. In some scenarios, the display format may include visibility options for the cell to display a limited number of the entries in a default (i.e., compressed or non-expanded) configuration of the cell along with a graphical device by which to display all the entries in a separate pane over the data table. For example, the display format may display a single entry in a default view of the cells while also providing a button to display an inline expansion view of the cell showing the two or three most recent entries in the cell and/or a button to display all the entries of the cell in a pop-up window or pane.

In some scenarios, the data table may be sorted according to the status column of multiple-entry cells, which is to say, according to an entry characteristic or content of the cells in the status column. For example, referring to the example scenario above, the rows of the data table may be sorted according to the oldest of the most recent entries of the status cells so that a task which has not received a recent update is more prominently positioned at the top of the table. In other situations, the data table may be sorted by the number of entries in a status cell, effectively sorting the tasks by activity level. Other table operations, such as filtering, may also be performed according to the status column based on an entry characteristic or content of an entry of the status cells.

Continuing with the example scenario above, multiple-entry cells of the status column may also be visually distinguished by color-coding the cells (e.g., changing the cells' background color) according to an entry characteristic or content of the cells. For example, the status cells may be color-coded according to the timestamp of the most recent entry so that a task that has not received a recent update is visually distinguished from other, more recently updated tasks. In some uses, the status column cells may be color-coded according to the user identity, for example, by color-coding the individual entries of each status cell according to user or by color-coding each status cell by the user who made the cell's most recent entry.

In various implementations, an application hosting a data table presents options for cell formatting depending on the intended use of the cell. For example, a user can select a currency-related format to display the user's entry along with the selected currency symbol, e.g., dollar sign, pound sign, etc. Similarly, according to technology disclosed herein, a user can select a multiple-entry format for a cell or group of cells, such as a row or column, which causes the application to store and display multiple individual entries to the formatted cell. In various implementations, as a user or multiple users enter information into a cell formatted for multiple entries, the application stores the content of the entry along with metadata or characteristics of the entry. When a user interacts with the formatted cell in a user interface of the application, the application executes logic, such as table operations, according to the stored information. For example, the application may include logic by which to display the multiple entries in a compressed form as well displaying an expanded form upon the user's request. Other operations include surfacing a new card when the user positions a cursor in the cell and capturing metadata or characteristics about an entry when the user begins a new entry or commits an entry to the cell.

Still other operations which may be performed by the application include table operations, such as sort commands or filter commands, which execute according to characteristics of the entries. For example, the user may perform a sort of multiple rows of a data table based on a column of cells with multiple-entry formatting, and the application may sort the table according to a characteristic of the entries. In a scenario, the user may sort the table according to the oldest update or according to the most recent update.

In various implementations, the application hosting the data table stores the entries of a multiple-entry-formatted cell, according to the cell address (e.g., row and column identifier), as a data object in including each entry and the one or more characteristics of each entry. The characteristics can include the timestamp (e.g., date and time) of each entry and the user identity associated with each entry. The data object, which may be structured in an Extensible Markup Language (XML) syntax or as a JavaScript Object Notation (JSON) object, organizes aspects of the data in a hierarchical structure forming parent-child relationships between elements. Each of the elements of the data structure may include attributes for the content that was entered by the user, the timestamp of entry, and the user identity. Other attributes may also be included, such as a format of the entry, a sort code for sorting the entries of the cell or for performing a table sort, and so on.

Technical effects of the technology disclosed herein include a cell format for cells of a data table by which an application can receive, store, and display multiple individual entries to a single cell by one or more users and display information relating to the content of the cell in a manner which preserves row and column proportions when displayed in the user interface, but which allows a user to easily view the multiple entries in an expanded format. The cell format further enables the cell entries to be displayed according to a characteristic of the entries, e.g., the order in which the entries were entered, the user making the entry, and so on. Moreover, enabling the cell to receive multiple individual entries serves as a proxy for a third dimension to data table in that information of the same type (e.g., project status information) but which is received at different times can be organized in the cell corresponding to the given row and column values.

In addition to the ability to store and manage multiple individual entries in a single cell, table operations may be performed on the data table with respect to the multiple-entry cells according to a particular characteristic of the cells. For example, a data table which includes a column of multiple-entry cells may be sorted according to a characteristic or content of a cell entry (e.g., the most recent entry, an alphabetical sort by the content of the most recent entry). Moreover, the multiple-entry cells can incorporate visual cues as to the content of the cells by color-coding the cells according to an entry. These visual cues enhance the user experience by reducing cognitive load (e.g., faster information processing, strengthening the user's attention or focus on more important content), improving user comprehension of the table contents, and facilitating a more efficient user experience.

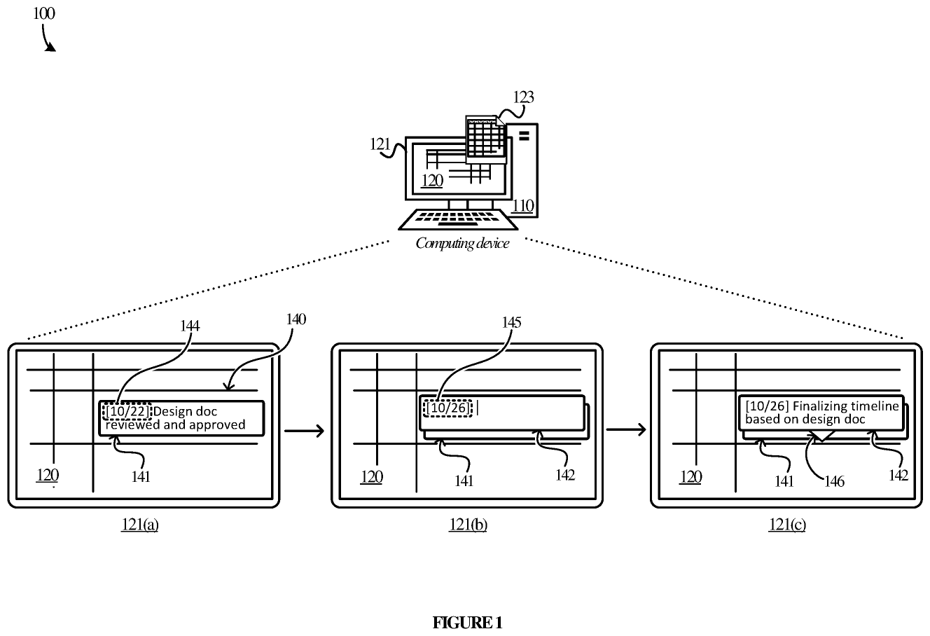

Turning now to the Figures, FIG. 1 illustrates operational environment 100 for multiple-entry formatting of cells in a data table in an implementation. Operational environment 100 includes computing device 110 hosting or executing a local runtime environment of an application displaying user experience 121. User experience 121 displays data table 120 and table data 123 among other functions, tools, and services which are not shown.

Operational environment 100 includes computing device 110 which hosts a local runtime environment of a software application. Computing device 110 displays user experience 121 (shown in various stages of operation as user experiences 121(a), 121(b), and 121(c)) of the application. Table data 123 is representative of tabular or structured data of data table 123 which is displayed in user experience 121.

Computing device 110 is representative any computing device, such as desktop and laptop computers, server computers, and mobile computing devices, which is capable of hosting a local runtime environment of an application which hosts structured or tabular data, such as spreadsheets, data tables, and the like. Examples of applications with host structured data include spreadsheet applications, database applications, applications for collaboration and project planning, as well as productivity applications such as word processing applications and slide presentation applications. Applications which host structured data include locally installed and executed applications, web-based applications that are executed in the context of a local web-browser application, and any variation or combination thereof. In some implementations, representative applications may be embedded in other applications and in accordance with numerous other frameworks including embedded frameworks and distributed frameworks.

In a brief operational example of the technology disclosed herein, data table 123 is displayed in user experience 121 including various rows and columns of data. Cell 140 of data table 123 is formatted for multiple entries. In user experience 121(a), card 141 is displayed including content entered by a user and timestamp 144 corresponding to when the entry was made. Moving to user experience 121(b), when a user seeks to make a new entry to cell 140, the user selects cell 140 (e.g., clicks on or arrows over to cell 140) which causes new card 142 to be displayed along with new timestamp 145 corresponding to a time of the new entry. The cursor is positioned in new card 142 to display the content entered by the user. In cell 140, when new card 142 is displayed, it is displayed as stacked on top of card 141 to alert users to the fact that cell 140 includes at least one more entry.

Continuing to user experience 121(c), the user keys in content for a new entry in new card 142. When the user commits the new entry to cell 140 (e.g., by hitting the Enter or Return key or saving the entry in association with the cell), cell 140 displays a compressed view of the multiple entries as a stack of cards 142 and 141. Cell 140 may be formatted to display the most recent entry of the multiple entries at the top of the stack based on an order of entry or timestamps of the entries. To see the entries of the stack, such as the content of card 141, a graphical device is displayed by which the user can cause the stack to be displayed in an expanded form (not shown) such that content of cards 141 and 142 is visible in user experience 121. In some implementations, individual cards or entries may be displayed by clicking on the portion of the card that is visible in the cell.

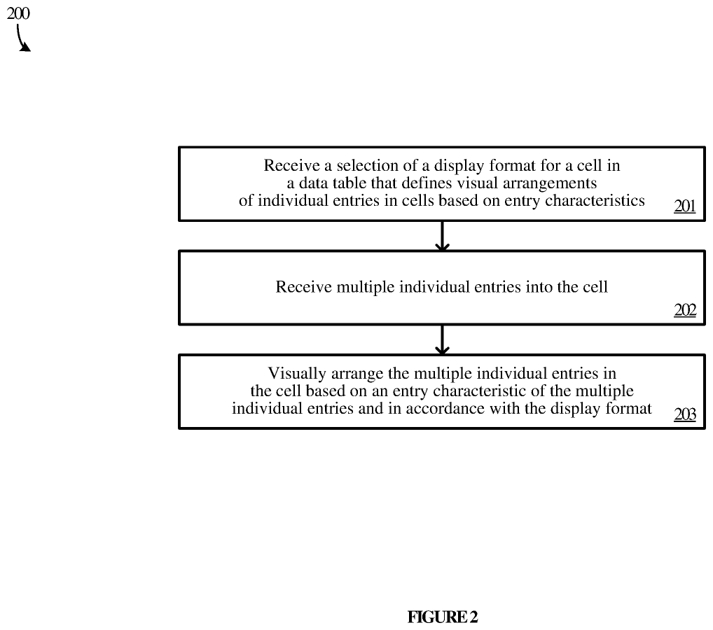

FIG. 2 illustrates a process for multiple-entry formatting of cells in data tables in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives a selection of a display format for a cell in a data table, where the selection defines visual arrangements of individual entries in cells based on entry characteristics (step 201). In an implementation, a user selects a cell or group of cells (e.g., row or column) and selects a multiple-entry format, say, from a drop-down menu of formatting choices. The multiple-entry format defines visual arrangements of multiple individual entries in a cell, such as a compressed view and expanded view, where the arrangements are based on an entry characteristic, such as the order of entry, when the entry is made (e.g., a timestamp of when the entry was initiated or committed to the cell), who made the entry (e.g., a user identifier associated with the entry), or some aspect of the content of the entry (e.g., the first letter of each entry for an alphabetical order of entries). In some scenarios, each entry may have other characteristics by which the visual arrangement is determined, such as a priority flag set by a user which causes flagged entries to be displayed more prominently or a sort code entered by a user for sorting the entries into a particular order.

The computing device receives multiple individual entries into the cell (step 202). In an implementation, a data table includes a cell which is selected (e.g., clicked on) by a user who then enters content into the cell (e.g., by typing in an entry or speaking an entry which is transcribed by a speech-to-text engine). In various implementations, when the user selects the cell, a blank card is displayed which displays the entry as it is entered. The blank card displays a timestamp corresponding to when the card was surfaced (i.e., when the user clicked on the cell) or when the user committed the entry to the cell. With the entry committed to the cell, the user may again select the cell, causing a second blank card to be surfaced over the previous entry. The user may enter new content into the second card and commit the entry to the card. The second card is displayed in the cell over the first card and with a timestamp associated with when the card was created or when the entry was committed to the cell. The process may continue with the user adding additional entries, each time causing a new card to be created for a new entry and a timestamp.

In various implementations, the blank card includes a priority flag which the user can set to cause an entry to be displayed more prominently (e.g., at the top of a card stack in the cell) and a graphical device by which to delete the card and its entry.

The computing device visually arranges the multiple individual entries in the cell based on an entry characteristic of the entries and in accordance with the display format (step 203). In an implementation, the multiple individual entries are displayed in a compressed view as a set of cards stacked or layered in a prescribed order, with each card displaying an entry, and with the prescribed order determined according to a characteristic of the entries. Where the characteristic is the same between two entries, the ordering may include a subsort based on a different characteristic. For example, in formatting the cell or group of cells, the user may elect to order the entries by time (e.g., most recent entry first) or by the user identifier associated with each entry (e.g., by an alphabetical order of user identifiers with a subsort by timestamp). The user may also elect to order the entries alphabetically by content (e.g., by the first letter of each entry). If the cards include a priority flag, any flagged entries in the cell may be sorted and displayed before the unflagged entries. Other visual arrangements of the entries may be tiles in the cell positioned adjacent to each other, with each tile displaying at least a portion of the entry.

The multiple-entry format may also include a second, expanded visual arrangement by which the entries can be displayed more fully than in the compressed view. In various implementations, the cell includes a graphical device by which to surface a pane in the user interface which displays the entries in the prescribed order. In other implementations, the expanded view may cause the cell proportions to be expanded to display the multiple cards more fully. In either case, the expanded view may include a scroll bar by which to view the cards in the stack.

In various implementations, the format for displaying the multiple entries includes color-coding the entries according to a characteristic of the entry, such as color-coding by user identifier, timestamp, or priority flagging. For example, where entries are displayed as cards, the card backgrounds may be color-filled according to timestamp so a user is alerted to recent activity. The card backgrounds may also be color-filled according to an elapsed time since the most recent entry, for example, to distinguish tasks which have not had recent activity. Alternatively, the card backgrounds may be color-filled according to the user identifier associated with each entry.

Referring again to FIG. 1, operational environment 100 demonstrates a brief example of process 200 as employed by elements of operational environment 100 in an implementation as follows. A user at computing device 110 views data table 120 in user experience 121. The user selects cell 140 (or the column which includes cell 140) and selects a format of the cell which accommodates multiple individual entries, such as entries which are entered into and committed to the cell at different times. The multiple individual entries may be entered by the same user or, where the data table is part of a shared canvas, by multiple users.

In user experience 121(a), a user views card 141 in cell 140 which includes an entry and timestamp 144 of the entry. The visual arrangement in cell 140 according to the selected format indicates that the cell includes a single card or single entry. In user experience 121(b), a user selects cell 140 to add a new entry to the cell. When the user clicks on cell 140, card 142 is surfaced including a cursor for positioning the entry of text in the cell and timestamp 145 corresponding to the date and/or time of entry. The visual arrangement in cell 140 includes a stack of cards to indicate the presence of multiple entries.

Continuing to user experience 121(c), the user has completed an entry in card 142. In an implementation, the visual arrangement orders the cards such that the most recent card or entry is displayed at the top of the stack so that its contents are at least partially visible. The date of entry is also displayed. Cell 140 also includes graphical device 146 by which a user can view the entries of all the cards in the stack. When graphical device 146 is selected, the entries are displayed in order in a display plan atop data table 123 or by expanding the size of cell 140 to show the entries within the cell.

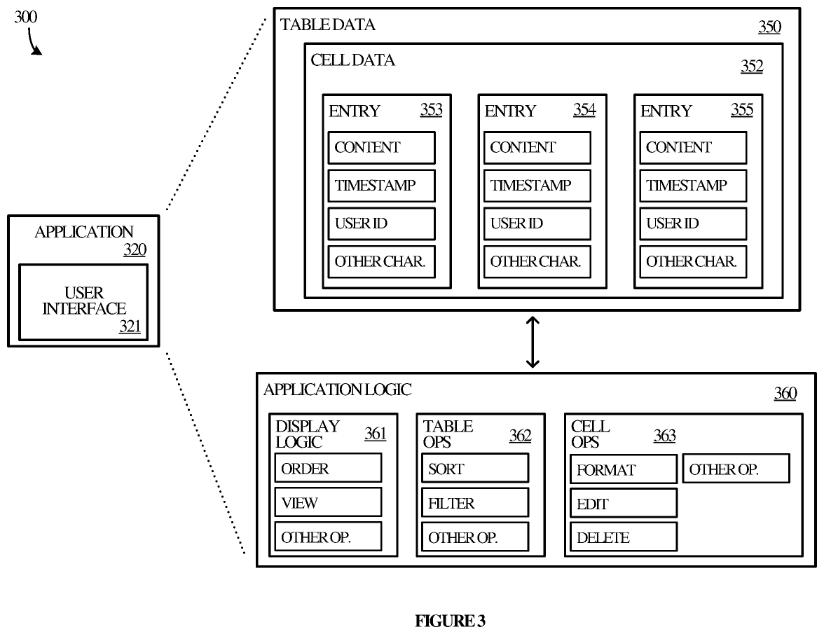

FIG. 3 illustrates operational architecture 300 for multiple-entry formatting of cells in a data table in an implementation. Operational architecture 300 includes application 320 hosting table data 350, application logic 360, and user interface 321. In various implementations, application 320 is representative of an application for hosting and displaying structured or tabular data, such as a collaborative or project planning application, spreadsheet application, database application, or other application capable of hosting and displaying of tabular data.

Table data 350 is representative of data for a data table, of which data table 123 is representative. Table data 350 includes cell data 352 which is representative of data for a multiple-entry formatted cell of a data table. Cell data 352 includes storage for multiple individual entries (such as entries 353, 354, and 355) of a multiple-entry formatted cell. The multiple-entry cell may include data in a structured format, e.g., in XML formatting or as a JSON data object. Entries 353, 354, and 355 include the entry content and entry characteristics of timestamp and user ID, and which may also include other characteristics. The content of a given entry of cell data 352 includes text entered by a user in the cell of cell data 352. The timestamp characteristic includes a date and/or time associated with the entry, such as the date/time when the entry was committed to the cell. The user ID includes an identifier associated with a user or user account of the entry. Other characteristics of the entry can include a priority flag set by a user when the entry is entered or a sort code by which the user can control the ordering of the multiple entries.

Application logic 360 of application 320 includes logic for storing and displaying multiple-entry formatted cells, for performing cell operations for multiple-entry formatted cells, and for performing table operations for tables which include multiple-entry formatted cells. Application logic 360 includes display logic 361, table operations 362, and cell operations 363. Display logic 361 includes logic by which the application executing application logic 360 generates visual arrangements of multiple-entry formatted cells in user interface 321. Display logic 361 includes instructions for ordering entries, such as entries 353, 354, and 356, according to the content or characteristics of the respective entry. Order logic can include logic by which to sort and sub-sort the entries. View logic of display logic 361 includes logic by which to display entries are displayed in a cell, i.e., in a compressed or compacted view, and in an expanded view, such as in a pane which displays the entries more fully or in the cell with the cell proportions enlarged to accommodate display of more of the entries' content. View logic of display logic 361 includes logic for displaying in user interface 321 a single entry, multiple entries, or no entries in a multiple-entry cell. For example, view logic may cause application 320 to display a single card for a cell with a single entry or a stack of cards for a cell with multiple entries. Similarly, view logic may cause application 320 to display a graphical device by which the user can elect to view an expanded view of multiple entries of a cell.

Application logic 360 also includes table operations 362 which includes row-wise or column-wise operations across multiple cells of a data table which has multiple-entry cells. Table operations 362 include logic or instructions for sorting, filtering, or performing other operations with respect to a table in accordance with the content or characteristics of a multiple-entry cell. Table operations 362 may include logic for performing an operation on the table according to the content or characteristics of a selected entry of the multiple-entry cell, including logic for selecting an entry of each cell for the purpose of the operation. For example, the logic may determine that the data table is sorted according to the timestamp of the most recent entry of a multiple-entry cell. Alternatively, the logic may determine that the table is sorted according to the timestamp of the most recent entry, with priority-flagged entries ordered before cells without priority-flagged entries. Or the logic may determine that the table is sorted according to an alphabetical order of the content of the multiple-entry cells with entries ordered according to user ID.

Cell operations 363 of application logic 360 includes logic or instructions for operations performed within a multiple-entry cell. In an implementation, cell operations 363 include operations performed at the entry-level and at the cell-level. At the entry-level, a user may edit or delete an entry, or perform other operations with respect to an entry.

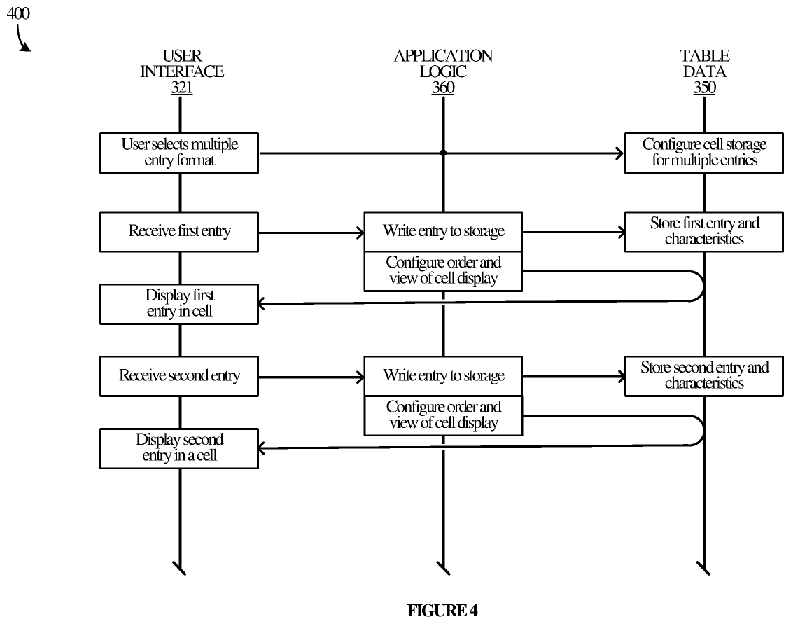

FIG. 4 illustrates workflow 400 for multiple-entry formatting of a cell in a data table referring to elements of operational architecture 300 in an implementation. Application 320 displays user interface 321 including table data 350 in a table. In user interface 321, a user selects a multiple-entry format for a cell (e.g., a single cell or a cell in a selected column) in the table. Application 320 executes logic, such as format logic of cell operations 363, to format the cell to accommodate multiple entries.

With the cell formatted, application 320 receives a first entry, such as text entered by a user, to the cell in user interface 321. Upon receiving the first entry in user interface 321, the application writes the entry to storage in table data 350 as entry 353. In writing the content of the entry to storage, application 320 also includes characteristics of the entry, such as the timestamp and the user ID associated with the entry. Application 320 also executes display logic 361 by which to display the cell. Display logic 361 determines the display of the cell based on factors such as the number of entries, parameters relating to the ordering of the entries, and the view (e.g., displaying the entry or multiple entries in the cell or surfacing an expanded display of the cell's contents). The multiple-entry cell including the first entry is displayed in user interface 321 based on display logic 361.

Next, application 320 receives a second entry to the cell in user interface 321. The second entry may be entered by the same user as the first entry or by a different user, for example, if application 320 is a shared or collaborative application. When the second entry is entered, application 320 writes the entry to storage in table data 350 as entry 354. In writing the content of the second entry to storage, application 320 also includes characteristics of the entry, such as the timestamp and the user ID associated with the second entry. Application 320 also executes display logic 361 by which to display the cell and its multiple entries. The multiple-entry cell including the first and second entries is displayed in user interface 321 based on display logic 361.

A user may continue to add entries to the cell. In some implementations, a user may edit or delete an entry or change a display parameter of the cell. For example, a user may re-order the entries from a display by timestamp to a display by user ID. Similarly, a user may perform a table operation with respect to multiple-entry cells in the table.

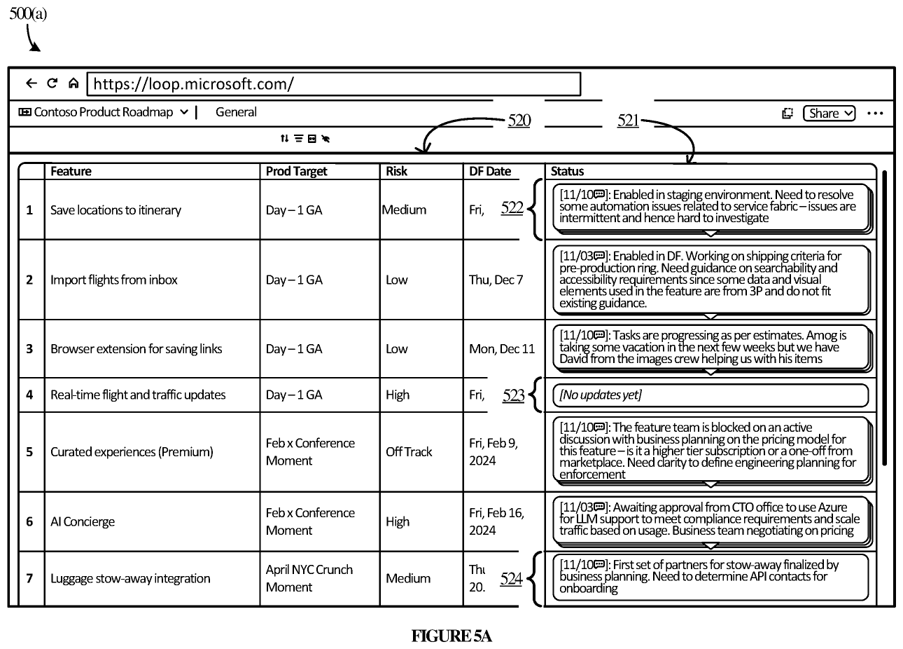

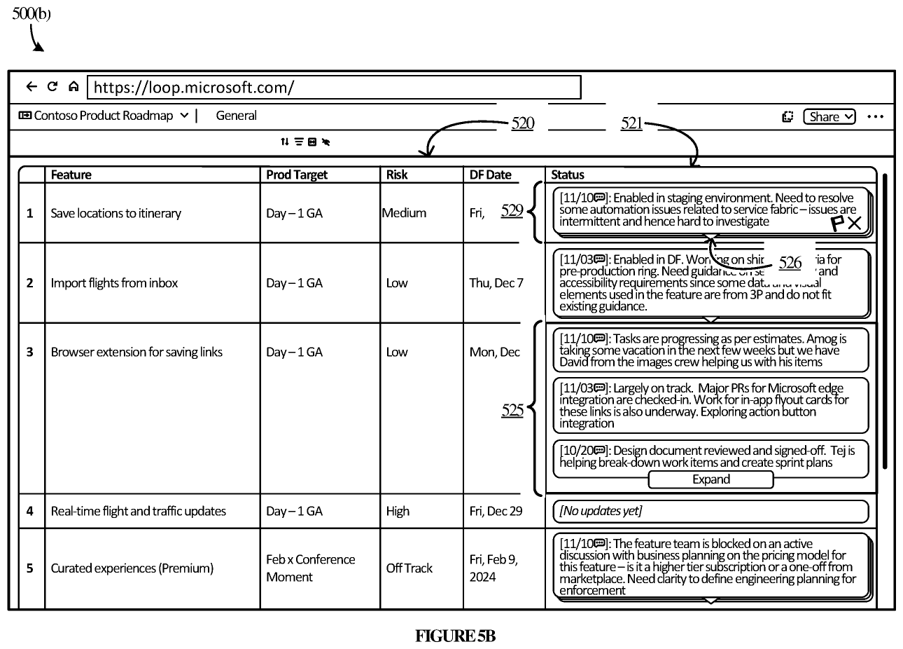

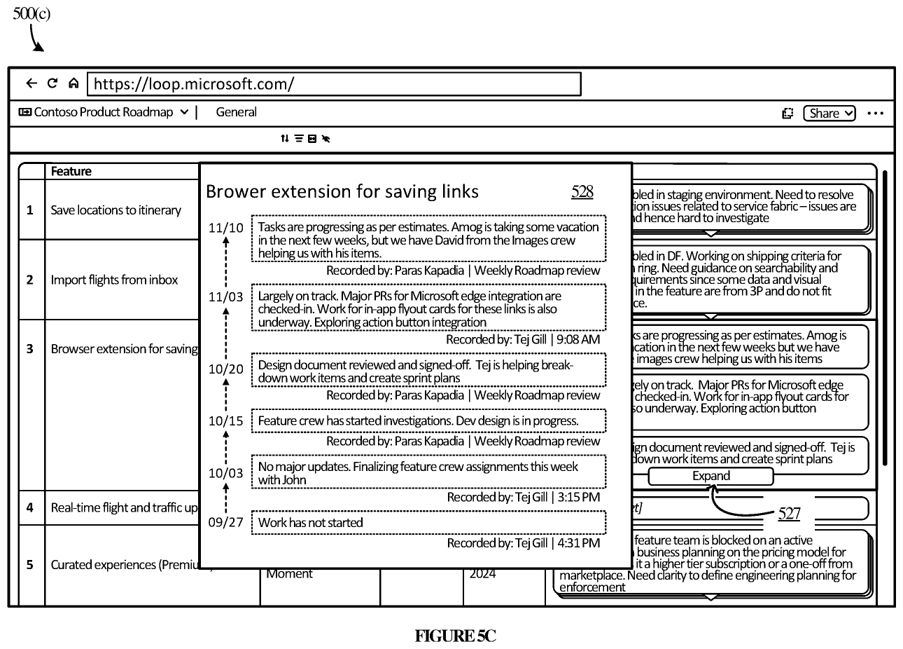

FIGS. 5A-5C illustrate user experience 500 of an application hosting a data table including multiple-entry cells (shown in various stages of operation as user experiences 500(a), (b), and (c)) in an implementation. In user experience 500(a) of FIG. 5A, data table 520 includes Status column 521 of multiple-entry cells. In Status column 521, cell 522 displays a stack of cards to visually indicate the presence of multiple entries in the cell in contrast to cell 524 which depicts a cell visually indicating the presence of a single entry according to a multiple-entry format. Cell 523 depicts a cell with no entries, displaying a blank card which can receive text when a user clicks on the cell. The populated cells of Status column 521 include a timestamp for the topmost or most recent entries and an expansion button by which to display other characteristics of the entries, such as user ID.

FIG. 5B depicts user experience 500(b) which includes cell 525 displaying an inline expansion view of the cell for displaying multiple entries as tiles or cards. The inline expansion display may be triggered when an inline expansion button (e.g., button 526) is selected, although in some scenarios an inline expansion of a multiple-entry cell may be triggered when the user selects or hovers over the cell. The display format for an inline expansion may include a visibility option set by the user to display a maximum number of cards or entries (e.g., up to three entries). For a default (non-expanded) cell display, such as is depicted with cell 529, the size or height of the tiles or cards may be scaled based on a maximum number of cards (e.g., one card) to be displayed, the amount of content in each card, or the allowable row height. For example, a portion of content of a card or tile may be displayed (rather than the entire content) according to a maximum number of text rows to be displayed in cell 525. Also depicted in cell 529 of user experience 500(b) are graphical devices by which a user can flag an entry for priority or delete the entry.

Turning to FIG. 5C, user experience 500(c) depicts pane 528 including an expanded view of cell 525 triggered by user selection of expansion button 527. Pane 528 displays the multiple entries of cell 525 ordered according to timestamp, including the contents of the multiple entries and the user ID characteristic of each entry. In some implementations, a meeting, call, or other event (e.g., “Weekly Roadmap review”) associated with each entry is also displayed with the entry.

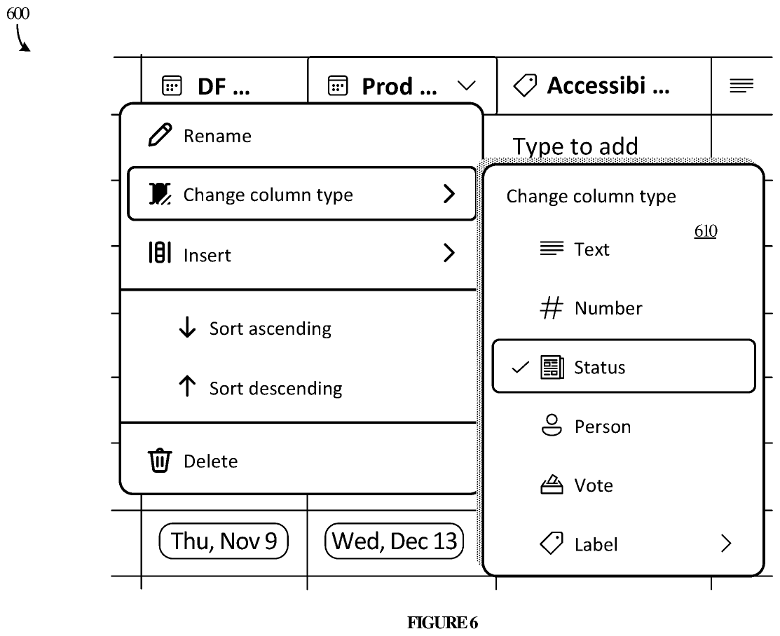

FIG. 6 illustrates user experience 600 of an application hosting a data table including multiple-entry cells in an implementation. User experience 600 of an application depicts menu 610 for selecting a column type for a user-selected column of a data table in the user interface. Menu 610 includes options for formatting cells of the data table according to a type or intended use of the cells. For example, the Status option formats the cells to receive multiple entries in accordance with the technology disclosed herein. In other implementations, the column type option for multiple-entry cells may be labeled in menu 610 in other terms, such as “Multiple Entry”. In some implementations, hovering over or clicking on the Status option may present another nested menu of sorting or ordering options by which the multiple entries are to be prioritized for display, such as by timestamp, by user ID, or by an alphabetical ordering by entry content, or visibility options for displaying a maximum number cards in the cell.

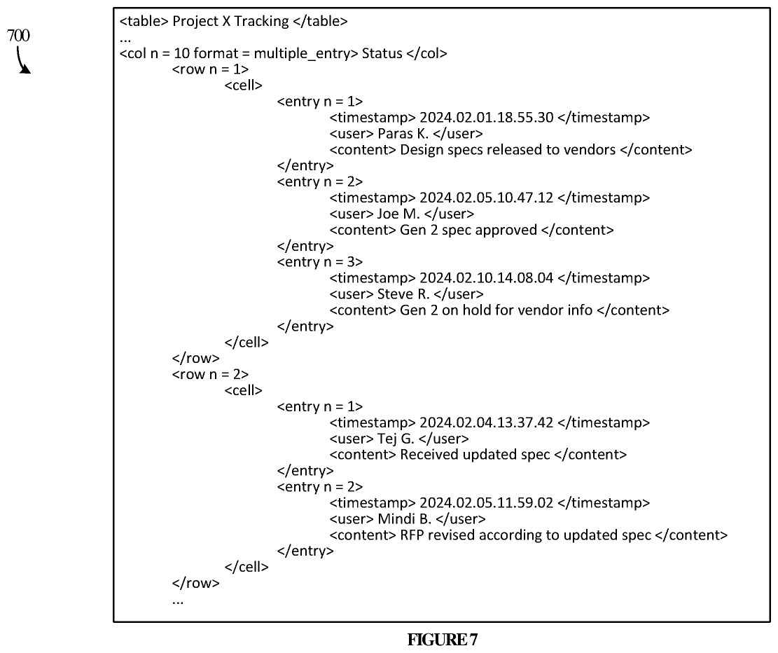

FIG. 7 depicts data structure 700 for holding data of cells of a multiple-entry-formatted column in data table in an implementation. Data structure 700 includes an XML structure or representation of a data table including elements and attributes in semantic tags which organize table data hierarchically by column, row, and cell. The data structure of a multiple-entry cell in data structure 700 includes elements for multiple entries enclosed in <entry>/</entry> tags. As illustrated, the elements may include an attribute tracking the order of entry. Each of the multiple entries includes the content and characteristics of the entry in appropriately labeled semantic tags. The entries may include other characteristics as well, such as an element for a priority flag status, an element for a sort code, and so on. The display logic of the application hosting the data table may order the entries in the cell according to a characteristic of each entry, such as the order of entry. In some implementations, other types of data structures may be used for storing data of multiple-entry cells, such as JSON objects.

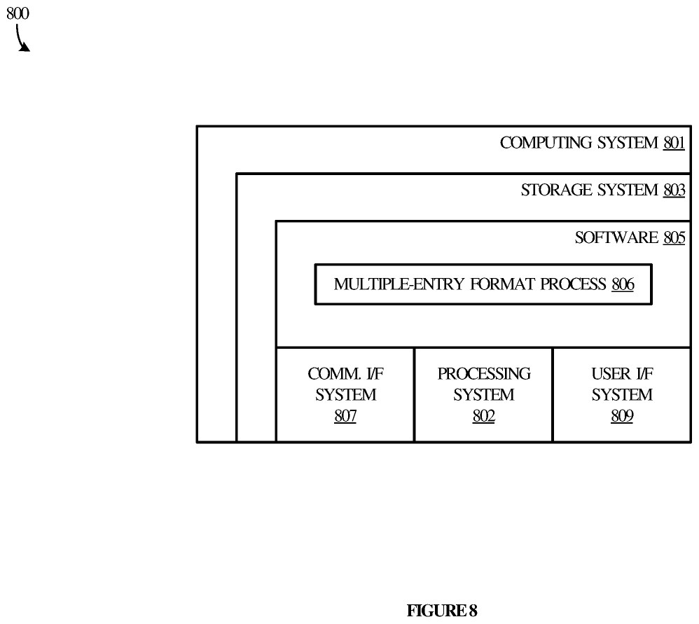

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements multiple-entry format process 806, which is (are) representative of the multiple-entry format processes discussed with respect to the preceding Figures, such as process 200 and workflow 400. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including multiple-entry format process 806) may be implemented in program instructions and among other functions may, when executed by processing system 802, direct processing system 802 to operate as described with respect to the various operational scenarios, sequences, and processes illustrated herein. For example, software 805 may include program instructions for implementing a multiple-entry format process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support multiple-entry format processes in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive, in a user interface of an application, a selection of a display format for a cell in a data table, wherein the display format defines visual arrangements of individual entries in cells based at least on entry characteristics of the individual entries;
receive multiple individual entries into the cell; and
visually arrange the multiple individual entries in the cell based on an entry characteristic of each of the multiple individual entries and in accordance with the display format.

2. The computing apparatus of claim 1, wherein to visually arrange the multiple individual entries based on the entry characteristic of each of the multiple individual entries and in accordance with the display format, the program instructions direct the computing apparatus to visually arrange the multiple individual entries as a set of cards layered in an order based on the entry characteristic of each of the multiple individual entries.

3. The computing apparatus of claim 2, wherein the entry characteristic comprises an order of entry of each of the multiple individual entries.

4. The computing apparatus of claim 2, wherein the entry characteristic comprises a user identity associated with each of the multiple individual entries.

5. The computing apparatus of claim 2, wherein the display format comprises at least a portion of an individual entry of the multiple individual entries, wherein the individual entry is determined based on the order.

6. The computing apparatus of claim 1, wherein the multiple individual entries comprise entries entered and committed to the cell at different times from other ones of the multiple individual entries.

7. The computing apparatus of claim 1, wherein the program instructions further direct the computing apparatus to receive user input comprising a request to display an expanded view of the multiple individual entries of the cell in the user interface.

8. The computing apparatus of claim 1, wherein to receive the selection of the display format for the cell, the program instructions direct the computing apparatus to receive the selection of the display format for a column of the data table which includes the cell.

9. A method of operating a computing device comprising:
receiving, in a user interface of an application, a selection of a display format for a cell in a data table, wherein the display format defines visual arrangements of individual entries in cells based at least on entry characteristics of the individual entries;
receiving multiple individual entries into the cell; and
visually arranging the multiple individual entries in the based on an entry characteristics of each of the multiple individual entries and in accordance with the display format.

10. The method of claim 9, wherein visually arranging the multiple individual entries based on the entry characteristic of each of the multiple individual entries and in accordance with the display format comprises visually arranging the multiple individual entries as a set of cards layered in an order based on the entry characteristic of each of the multiple individual entries.

11. The method of claim 10, wherein the entry characteristic comprises an order of entry of each of the multiple individual entries.

12. The method of claim 10, wherein the entry characteristic comprises a user identity associated with each of the multiple individual entries.

13. The method of claim 10, wherein the display format comprises at least a portion of an individual entry of the multiple individual entries, wherein the individual entry is determined based on the order.

14. The method of claim 9, wherein the multiple individual entries comprise entries entered and committed to the cell at different times from other ones of the multiple individual entries.

15. The method of claim 9, further comprising receiving user input comprising a request to display an expanded view of the multiple individual entries in the user interface.

16. One or more computer readable storage media having program instructions stored thereon that, when executed by one or more processors, direct a computing device to at least:
receive, in a user interface of an application, a selection of a display format for a cell in a data table, wherein the display format defines visual arrangements of individual entries in cells based at least on entry characteristics of the individual entries;
receive multiple individual entries into the cell; and
visually arrange the multiple individual entries in the cell based on an entry characteristic of each of the multiple individual entries and in accordance with the display format.

17. The one or more computer readable storage media of claim 16, wherein to visually arrange the multiple individual entries based on the entry characteristic of each of the multiple individual entries and in accordance with the display format, the program instructions direct the computing device to visually arrange the multiple individual entries as a set of cards layered in an order based on the entry characteristic of each of the multiple individual entries.

18. The one or more computer readable storage media of claim 17, wherein the entry characteristic comprises an order of entry of each of the multiple individual entries.

19. The one or more computer readable storage media of claim 17, wherein the entry characteristic comprises a user identity associated with each of the multiple individual entries.

20. The one or more computer readable storage media of claim 17, wherein the display format comprises at least a portion of an individual entry of the multiple individual entries, wherein the individual entry is determined based on the order.
